(19) United States
(12) Patent Application Publication
(10) Pub. No.: US 2023/0202127 A1
(43) Pub. Date: Jun. 29, 2023

(54) SYSTEM AND METHOD FOR MANUFACTURING A COMPOSITE STRUCTURE

(71) Applicant: LM Wind Power A/S, Kolding (DK)

(72) Inventor: Karsten SCHIBSBYE, Kolding (DK)

(21) Appl. No.: 17/926,768

(22) PCT Filed: May 20, 2021
(86) PCT No.: PCT/EP2021/063491

§ 371 Date: Nov. 21, 2022

(30) Foreign Application Priority Data
May 26, 2020 (GB) 2007798.8

(51) Int. Cl. B29C 70/54; B29C 70/38

(52) U.S. Cl. CPC B29C 70/54; B29C 70/382

(57) ABSTRACT

Disclosed is a method and a system for manufacturing a composite structure, such as a wind turbine blade. The system comprises: a first mould; a second mould; a monorail arranged between the first mould and the second mould; and a primary mobile unit configured to mount the monorail and comprising: a first distributor configured to distribute first fibre material in the first mould; and a first cover handler configured to arrange a first cover material over the distributed first fibre material in the first mould, to lock the first fibre material in the first mould.

The present disclosure relates to manufacturing of a composite structure, such as a wind turbine blade, more particular the present disclosure relates to a system and a method for manufacturing a composite structure, such as a wind turbine blade.

### BACKGROUND

Structures of composite material, such as wind turbine blades, in particular the aerodynamic shells of wind turbine blades, are usually manufactured in moulds by arranging glass fibre and/or other fibre-reinforcement material, such as carbon fibre, in the moulds. In some cases two half elements, such as a downwind shell and an upwind shell of a wind turbine blade may be formed in individual moulds, which after infusion and curing of a resin, one of the two halves are turned upside down and positioned on top of the other of the two halves. The two half structures may be glued together.

Layup of fibre, e.g. glass fibre and/or carbon fibre, may be done by laying up mats of dry fibre material, where the fibre material may be arranged in pre-specified orientations to achieve the desired strength in desired directions of the structure. Afterwards a resin may be infused and cured, e.g. using vacuum assisted resin transfer moulding (VARTM), to fix the orientation and position of the fibres. Another method involves laying up so called pre-pregs, which are fibre mats being pre-infused with a resin. Yet another method exists where rovings of dry fibre are layed up in the mould, in the direction to achieve the desired strength of the structure.

EP 3 003 696 discloses a method for laying a fibre material on a mould surface, in which rovings of the fibre material are laid on the mould surface or on a fibre material already laid on the mould surface. The solution involves a pair of tracks arranged along the side of the mould, and two separate gantries spanning the track pair and carrying a distributor for distributing a fibre material and a handling tool for handling a cover sheet, respectively.

### SUMMARY

It is an object of the present disclosure to provide a manufacturing method that is fast and convenient, and which improves manufacturing of composite structures, such as wind turbine blades, e.g. by reducing manufacturing time.

Particularly, it is an object of the present disclosure to provide a system which optimizes space requirements and reduces complexity of known solution.

Thus, the present disclosure relates to a system for manufacturing a composite structure, such as a wind turbine blade. The system comprises a first mould configured for forming a first part of the composite structure. The first mould is arranged substantially along a longitudinal direction. The system further comprises a second mould configured for forming a second part of the composite structure. The second mould is arranged substantially along the longitudinal direction.

The system comprises a monorail arranged between the first mould and the second mould substantially along the longitudinal direction. The monorail may be laid on the ground. Alternatively, the monorail may be overhanging, e.g. the monorail may be attached to and hanging from a ceiling and/or may be attached to a wall.

Utilizing a monorail arranged between the first mould and the second mould facilitates a more compact manufacturing system taking up less space in the production hall, resulting in a more optimal exploitation of the production site.

The system comprises a primary mobile unit configured to mount the monorail. The primary mobile unit comprises a first a first distributor configured to distribute first fibre material in the first mould, and a first cover handler configured to arrange a first cover material over the distributed first fibre material in the first mould, to lock the first fibre material in the first mould.

The present disclosure further relates to a method for manufacturing a composite structure, such as a wind turbine blade, e.g. using the disclosed system. The method comprises arranging, substantially along a longitudinal direction, a first mould, such as the first mould of the disclosed system, configured for forming a first part of the composite structure. The method further comprises arranging, substantially along the longitudinal direction, a second mould, such as the second mould of the disclosed system, configured for forming a second part of the composite structure. The method further comprises arranging a monorail, such as the monorail of the disclosed system, between the first mould and the second mould substantially along the longitudinal direction. For example, the monorail may be laid on the ground, may be attached to a ceiling and/or may be attached to a wall.

The method further comprises mounting a primary mobile unit, such as the primary mobile unit of the disclosed system, to the monorail, wherein the primary mobile unit comprising a first distributor and a first cover handler.

The method further comprises distributing, by the first distributor, first fibre material in the first mould, and arranging by the first cover handler a first cover material over the distributed first fibre material in the first mould to lock the first fibre material in the first mould.

The system may further comprise a second distributor configured to distribute second fibre material in the second mould, and a second cover handler configured to arrange a second cover material over the distributed second fibre material in the second mould, to lock the second fibre material in the second mould. Accordingly, the method may comprise distributing, by the second distributor, second fibre material in the second mould, and arranging, by the second cover handler, a second cover material over the distributed second fibre material in the second mould, to lock the second fibre material in the second mould.

The primary mobile unit may comprise the second distributor and the second cover handler. For example, the primary mobile unit may span across the first mould and the second mould. The primary mobile unit may have a centre, e.g. a centre of mass, substantially located above the monorail. For example, the second distributor and the second cover handler may function to balance the first distributor and the first cover handler.

Alternatively, the system may comprise a secondary mobile unit configured to mount the monorail. The method may comprise mounting the secondary mobile unit to the monorail. The secondary mobile unit may comprise the second distributor and the second cover handler.

The primary mobile unit and/or the secondary mobile unit may be movable along the monorail, e.g. along the longitudinal direction. The primary mobile unit and the secondary mobile unit may be movable independently along the monorail.

Providing for both the first distributor and the second distributor attached to the same monorail, allows for simultaneous layup of fibre in two moulds e.g. two half moulds to form a single structure, such as a single wind turbine blade. Thus, manufacturing time is reduced while reducing the number of elements of the manufacturing system.

The system may comprise a controller. The controller may be configured to control the primary mobile unit, the secondary mobile unit, the first distributor, the first cover handler, the second distributor and/or the second cover handler. For example, the controller may be configured to control movement of the primary mobile unit and/or movement of the secondary mobile unit, e.g. along the monorail and/or along the longitudinal direction.

The controller may be configured to control the first distributor and the first cover handler, such as to coordinate distribution of the first fibre material and the arrangement of the first cover material over the distributed first fibre material.

The controller may be configured to control the second distributor and the second cover handler, such as to coordinate distribution of the second fibre material and the arrangement of the second cover material over the distributed second fibre material.

The first cover material may lock the first fibre material in the first mould by friction, e.g. aided by gravity. The first cover material may be a rubber mat. The second cover material may lock the second fibre material in the second mould by friction, e.g. aided by gravity. The second cover material may be a rubber mat. The first cover material and the second cover material may be of a similar material, such as rubber, such as synthetic rubber. The first cover material and/or the second cover material may have a weight between 1-25 kg/m2, such as between 5-20 kg/m2, such as approximately 5 kg/m2 or approximately 10 kg/m2 or approximately 15 kg/m2. Providing a cover material being sufficiently heavy facilitates locking of the fibres by use of merely gravity.

Arranging the first cover material over the distributed first fibre material may comprise unrolling the first cover material over the distributed first fibre material. The first cover handler may comprise a roll of the first cover material. The first cover handler may be configured to arrange the first cover material over the distributed first fibre material by unrolling the first cover material over the distributed first fibre material. The second cover handler may comprise a roll of the second cover material. The second cover handler may be configured to arrange the second cover material over the distributed second fibre material by unrolling the second cover material over the distributed second fibre material.

The first cover material may have been previously arranged over previously distributed fibre material in the first mould. The method may comprise lifting the first cover material by the first cover handler before distributing the first fibre material. The first cover handler may be configured to lift the first cover material, e.g. to allow distribution of the first fibre material by the first distributor. The second cover material may have been previously arranged over previously distributed fibre material in the second mould. The method may comprise lifting the second cover material by the second cover handler before distributing the second fibre material. The second cover handler may be configured to lift the second cover material, e.g. to allow distribution of the second fibre material by the second distributor.

A first secondary cover material may be arranged over previously distributed fibre material in the first mould. The method may comprise lifting the first secondary cover material by a first secondary cover handler, e.g. of the primary mobile unit, before distributing the first fibre material. The primary mobile unit may comprise a first secondary cover handler configured to lift the first secondary cover material. For example, the first secondary cover handler may comprise a roll to roll up the first secondary cover material.

A second secondary cover material may be arranged over previously distributed fibre material in the second mould. The method may comprise lifting the second secondary cover material by a second secondary cover handler, e.g. of the secondary mobile unit, before distributing the second fibre material. The primary mobile unit and/or the secondary mobile unit may comprise a second secondary cover handler configured to lift the second secondary cover material. For example, the second secondary cover handler may comprise a roll to roll up the second secondary cover material.

### BRIEF DESCRIPTION OF THE FIGURES

Embodiments of the disclosure will be described in more detail in the following with regard to the accompanying figures. The figures show one way of implementing the present disclosure and are not to be construed as being limiting to other possible embodiments falling within the scope of the attached claim set.

FIG. 1 schematically illustrates a conventional modern upwind wind turbine,

FIG. 2 schematically illustrates an exemplary wind turbine blade,

FIG. 3 is a schematic diagram illustrating an exemplary system,

FIG. 4-6 are schematic diagrams illustrating exemplary mobile units,

FIG. 7 is a block diagram of an exemplary system, and

FIG. 8 is a flowchart of an exemplary method.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

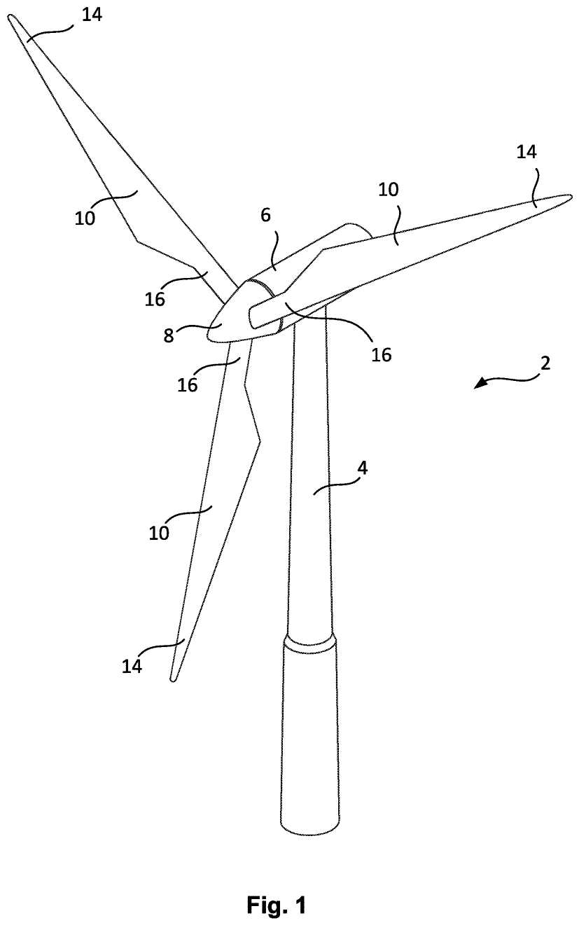

FIG. 1 schematically illustrates a conventional modern upwind wind turbine 2 according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 furthest from the hub 8.

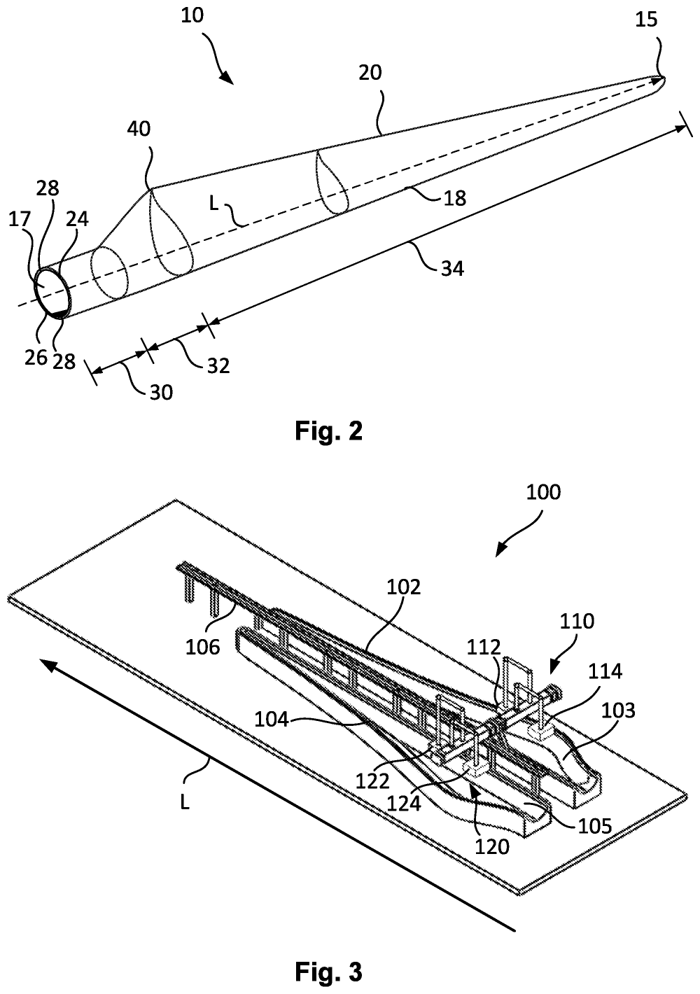

FIG. 2 schematically illustrates an exemplary wind turbine blade 10. The wind turbine blade 10 has the shape of a conventional wind turbine blade with a root end 17 and a tip end 15 and comprises a root region 30 closest to the hub, a profiled or an airfoil region 34 furthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance from the hub.

A shoulder 40 of the blade 10 is defined as the position, where the blade 10 has its largest chord length. The shoulder 40 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The wind turbine blade 10 comprises a blade shell comprising two blade shell parts or half shells, a first blade shell part 24 and a second blade shell part 26, typically made of fibre-reinforced polymer. The wind turbine blade 10 may comprise additional shell parts, such as a third shell part and/or a fourth shell part. The first blade shell part 24 is typically a pressure side or upwind blade shell part. The second blade shell part 26 is typically a suction side or downwind blade shell part. The first blade shell part 24 and the second blade shell part 26 are fastened together with adhesive, such as glue, along bond lines or glue joints 28 extending along the trailing edge 20 and the leading edge 18 of the blade 10. Typically, the root ends of the blade shell parts 24, 26 has a semi-circular or semi-oval outer cross-sectional shape.

FIG. 3 is a schematic diagram illustrating an exemplary system 100 for manufacturing a wind turbine blade, such as the wind turbine blade 10 as illustrated in FIG. 2. The system comprises a first mould 102 and a second mould 104. The first mould 102 is configured for forming a first blade shell part of the wind turbine blade, such as an upwind shell part of the wind turbine blade. The second mould 104 is configured for forming a second blade shell part of the wind turbine blade, such as a downwind shell part of the wind turbine blade. The first mould 102 and the second mould 104 are arranged substantially along a longitudinal direction L.

The first mould 102 has a first moulding surface 103. The second mould 104 has a second moulding surface 105. The system 100 is configured, e.g. by a positioning device (not shown), to position the first mould 102 and the second mould 104 such that the first moulding surface 103 of the first mould 102 is facing the second moulding surface 105 of the second mould 104 and such that the first blade shell part may be bonded, e.g. glued, with the second blade shell part so as to form the blade shell of the wind turbine blade.

The system 100 comprises a monorail 106 arranged between the first mould 102 and a second mould 104. The monorail 106 is arranged substantially along the longitudinal direction L. The monorail 106 may be laid out on the ground as illustrated. Alternatively, the monorail 106 may be hanging from a ceiling and/or attached to or extending from a wall.

The system 100 comprises a primary mobile unit 110 configured to mount the monorail 106. The primary mobile unit 110 is movable along the monorail 106 along the longitudinal direction L. The primary mobile unit 110 comprises a first distributor 112 configured to distribute first fibre material in the first mould 102, e.g. on the first moulding surface 103. The primary mobile unit 110 further comprises a first cover handler 114 configured to arrange a first cover material over the distributed first fibre material in the first mould 102, to lock the first fibre material in the first mould 102. In the present example, the first distributor 112 and the first cover handler 114 are shown as two individual robotic arms arranged on a vertical beam of the primary mobile unit 110. However, alternatively, the first distributor 112 and the first cover handler 114 may be arranged in a single unit e.g. attached to the vertical beam of the primary mobile unit 110 by a robotic arm.

As illustrated in the present example, the system 100 may facilitate simultaneous layup of fibre in the first mould 102 and the second mould 104. For example, the system 100, as illustrated, comprises a second distributor 122 configured to distribute second fibre material in the second mould 104, e.g. on the second moulding surface 105. The system 100, as illustrated, further comprises a second cover handler 124 configured to arrange a second cover material over the distributed second fibre material in the second mould 104, to lock the second fibre material in the second mould 104. The second distributor 122 and/or the second cover handler 124 may be comprised by the primary mobile unit 110, e.g. such that the first distributor 112 and the first cover handler 114 travels along the first mould 102 and the second mould 104, together with the second distributor 122 and the second cover handler 124. Alternatively, the system 100 may comprise a secondary mobile unit, e.g. movable along the monorail, along the longitudinal direction, independently of the primary mobile unit, and the secondary mobile unit may comprise the second fibre distributor 122 and the second cover handler 124.

The system is configured to coordinate distribution of the first fibre material by the first distributor 112 and the arrangement of the first cover material by the first cover handler 114. The system is further configured to coordinate distribution of the second fibre material by the second distributor 122 and the arrangement of the second cover material by the second cover handler 124. For example, as will described in more detail below, the system may comprise a controller configured to control the primary mobile unit 110, the secondary mobile unit 120, the first distributor 112, the first cover handler 114, the second distributor 122 and/or the second cover handler 124.

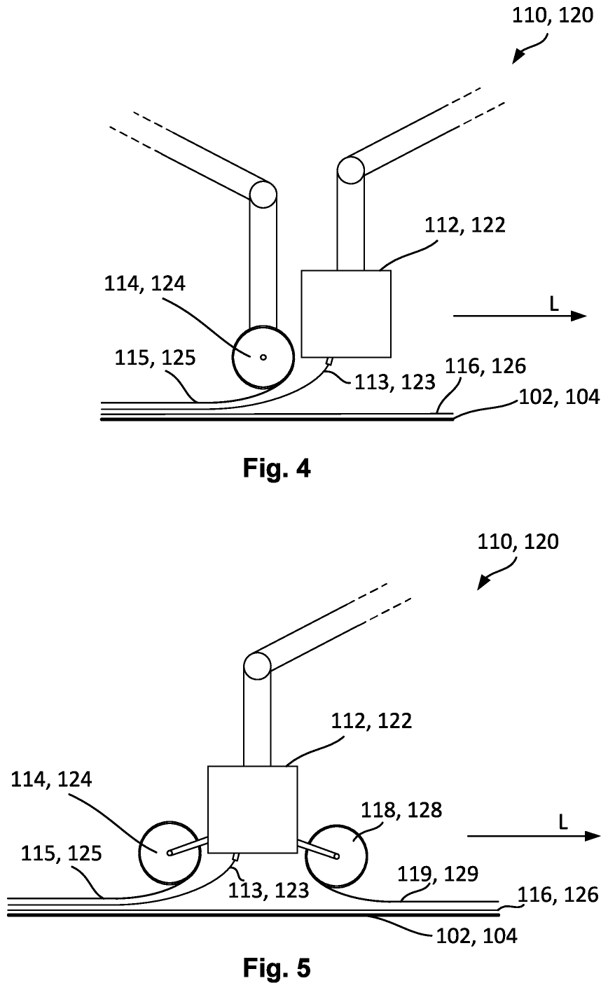

FIG. 4 is a schematic diagram illustrating an exemplary mobile unit 110, 120, such as the primary mobile unit 110 and/or the secondary mobile unit 120 as described with respect to FIG. 3. The mobile unit 110, 120 comprises a distributor 112, 122 configured to distribute fibre material 113, 123 in the respective mould 102, 104. The mobile unit 110, 120 further comprises a cover handler 114, 124 configured to arrange a cover material 115, 125 over the distributed fibre material 113, 123 to lock the fibre material 113 123 in the mould 102, 104.

As the mobile unit 110, 120 travels along the longitudinal direction L, the distributor 112, 122 may distribute fibre material 113, 123 in the mould 102, 104, and the cover handler 114, 124 may travel behind and unroll a cover material 115, 125 to lock the fibre material 113, 123 in the mould by friction, e.g. aided by gravity. Hence, the cover material 115, 125 may have a substantial weight to hold down the distributed fibre material 113, 123. For example, the cover material 115, 125 may be a rubber mat.

FIG. 5 is a schematic diagram illustrating an alternative exemplary mobile unit 110, 120, such as the primary mobile unit 110 and/or the secondary mobile unit 120 as described with respect to FIG. 3. The exemplary mobile unit 110, 120 of FIG. 5 comprises the same features as the exemplary mobile unit 110, 120 of FIG. 4. However, the cover handler 114, 124 of the mobile unit 110, 120 of FIG. 5 is coupled with the distributor 112, 122.

Furthermore, the mobile unit 110, 120 of FIG. 5, further illustrates that the mobile unit 110, 120 may comprise a secondary cover handler 118, 128 configured to lift a first secondary cover material 119, 129 arranged over previously distributed fibre material 116, 126 in the mould. It should be understood that a secondary cover handler 118, 128 may also be combined with the exemplary mobile unit 110, 120 as exemplified in FIG. 4.

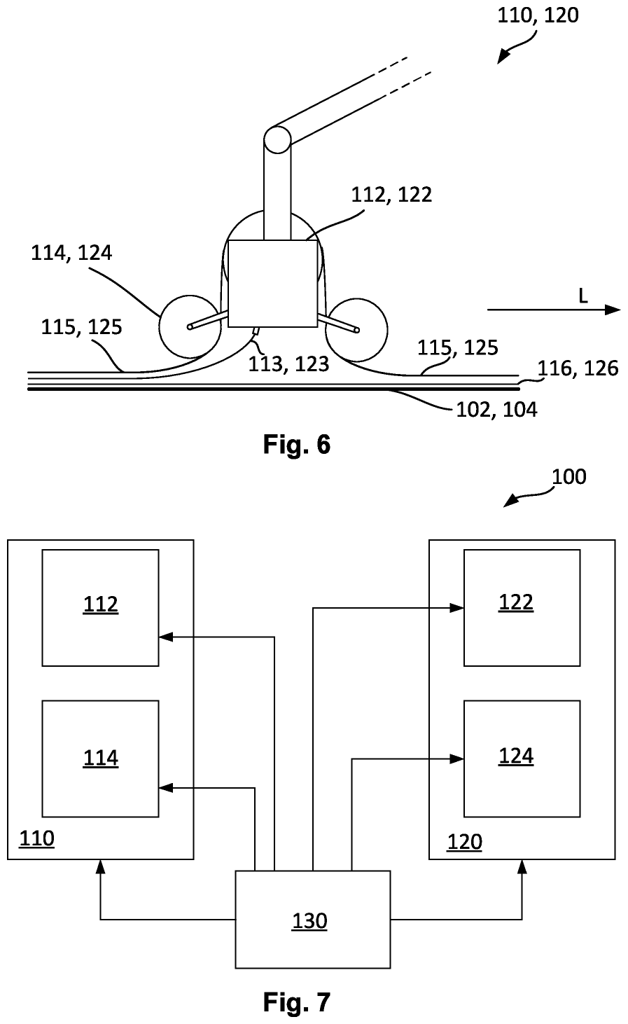

FIG. 6 is a schematic diagram illustrating an alternative exemplary mobile unit 110, 120, such as the primary mobile unit 110 and/or the secondary mobile unit 120 as described with respect to FIG. 3. The exemplary mobile unit 110, 120 of FIG. 5 comprises the same features as the exemplary mobile unit 110, 120 of FIG. 4. However, the cover handler 114, 124 of the mobile unit 110, 120 of FIG. 6 is coupled with the distributor 112, 122, as in FIG. 5.

Furthermore, the mobile unit 110, 120 of FIG. 6, further illustrates that the cover handler 114, 124 is further configured to lift the cover material 115, 125 being arranged over previously distributed fibre material 116, 126 in the mould 102, 104.

In the example, as illustrated in FIG. 6, a cover material 115, 125, previously having been arranged over distributed fibre material 116, 126, may be lifted to allow the distributor 112, 122 to distribute fibre material 113, 123 in the mould 102, 104, while after distribution of the fibre material 113, 123 the cover material 115, 125 is again arranged in the mould 102, 104, this time over the distributed fibre material 113, 123. In the alternative example, as illustrated in FIG. 5 a previously arranged cover material 119, 129 is rolled up by the secondary cover handler 118, 128 to allow the distributor 112, 122 to distribute the fibre material 113, 123 in the mould 102, 104, and after distribution of the fibre material 113, 123 another cover material 115, 125 is arranged in the mould 102, 104 over the distributed fibre material 113, 123.

FIG. 7 is a block diagram of an exemplary system, such as the system 100 as described above in relation to FIG. 3. The system 100 comprises a primary mobile unit 110 comprising a first distributor 112 configured to distribute first fibre material in a first mould, and a first cover handler 114 configured to arrange a first cover material over the distributed first fibre material in the first mould. Furthermore, the system 100 may comprise a secondary mobile unit 120 comprising a second distributor 122 configured to distribute second fibre material in a second mould, and a second cover handler 124 configured to arrange a second cover material over the distributed second fibre material in the second mould. As mentioned above, in an alternative embodiment, the second distributor 122 and the second cover handler 124 may be provided on the primary mobile unit 110 together with the first distributor 112 and the first cover handler 114.

The system 100 comprises a controller 130 configured to control the primary mobile unit 110, the secondary mobile unit 120, the first distributor 112, the first cover handler 114, the second distributor 122 and the second cover handler 124. For example, the controller 130 may be configured to control movement of the primary mobile unit 110 and/or the secondary mobile unit 120, e.g. along the monorail as described with respect to FIG. 3.

The controller 130 may be configured to control the first distributor 112 and the first cover handler 114, such as to coordinate distribution of the first fibre material by the first distributor 112 and the arrangement of the first cover material by the first cover handler 114 over the distributed first fibre material.

The controller 130 may be configured to control the second distributor 122 and the second cover handler 124, such as to coordinate distribution of the second fibre material by the second distributor 122 and the arrangement of the second cover material by the second cover handler 124 over the distributed second fibre material.

Although not specifically illustrated in FIG. 7, it will be understood that the controller 130 may be configured to control a secondary cover handler, such as a first secondary cover handler and/or a second secondary cover handler, as described with respect to FIG. 5.

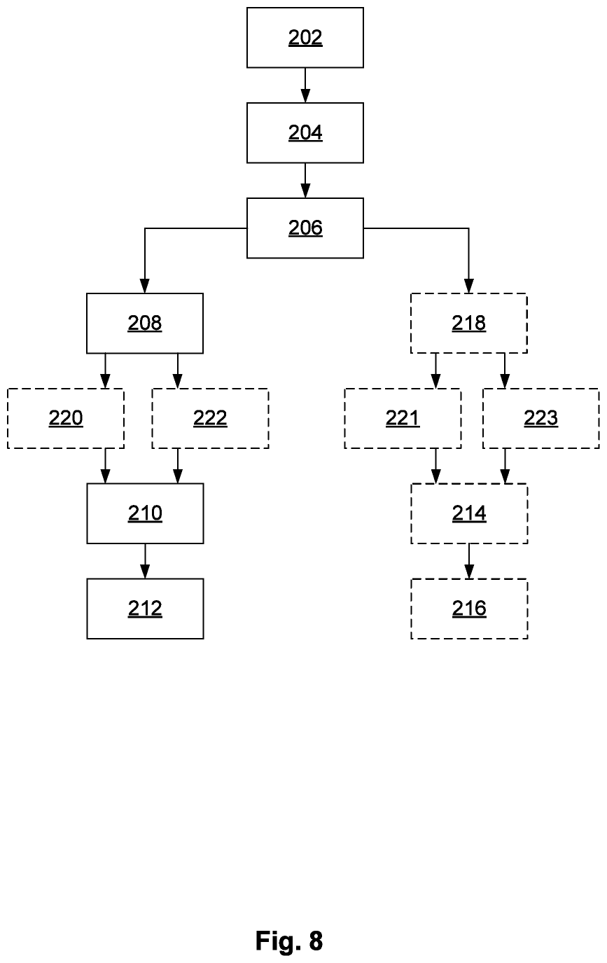

FIG. 8 is a flowchart of an exemplary method 200 for manufacturing a composite structure, such as a wind turbine blade.

The method 200 comprises: arranging 202, substantially along a longitudinal direction, a first mould configured for forming a first part of the composite structure; arranging 204, substantially along the longitudinal direction, a second mould configured for forming a second part of the composite structure; arranging 206 a monorail between the first mould and the second mould substantially along the longitudinal direction; and mounting 208 a primary mobile unit to the monorail. The primary mobile unit comprises a first distributor and a first cover handler.

The method 200 further comprises: distributing 210, by the first distributor, first fibre material in the first mould; and arranging 212 by the first cover handler a first cover material over the distributed first fibre material in the first mould to lock the first fibre material in the first mould.

The method may further comprise: distributing 214, by a second distributor, second fibre material in the second mould; and arranging 216, by a second cover handler, a second cover material over the distributed second fibre material in the second mould, to lock the second fibre material in the second mould. The primary mobile unit may comprise the second distributor and/or the second cover handler. Alternatively, the method may comprise mounting 218 a secondary mobile unit to the monorail, wherein the secondary mobile unit comprises the second distributor and the second cover handler.

Distributing 214 the second fibre material in the second mould and arranging 216 the second cover material in the second mould may be performed simultaneously with distributing 210 the first fibre material in the first mould and arranging 212 the first cover material in the first mould.

Arranging 212 the first cover material over the distributed first fibre material may comprise unrolling the first cover material over the distributed first fibre material. Arranging 216 the second cover material over the distributed second fibre material may comprise unrolling the second cover material over the distributed second fibre material.

In some examples, the first cover material may be arranged over previously distributed fibre material in the first mould. Thus, the method 200 may comprises lifting 220 the first cover material by the first cover handler before distributing 210 the first fibre material. Alternatively, a first secondary cover material may be arranged over previously distributed fibre material in the first mould. Thus, the method 200 may comprises lifting 222 the first secondary cover material by a first secondary cover handler, e.g. of the primary mobile unit before distributing the first fibre material.

In some examples, the second cover material may be arranged over previously distributed fibre material in the second mould. Thus, the method 200 may comprises lifting 221 the second cover material by the second cover handler before distributing 214 the second fibre material. Alternatively, a second secondary cover material may be arranged over previously distributed fibre material in the second mould. Thus, the method 200 may comprises lifting 223 the second secondary cover material by a second secondary cover handler, e.g. of the primary mobile unit or the secondary mobile unit, before distributing the second fibre material.

The disclosure has been described with reference to a preferred embodiment. However, the scope of the invention is not limited to the illustrated embodiment, and alterations and modifications can be carried out without deviating from the scope of the invention.

Throughout the description, the use of the terms “first”, “second”, “third”, “fourth”, “primary”, “secondary”, “tertiary” etc. does not imply any particular order or importance, but are included to identify individual elements. Furthermore, the labelling of a first element does not imply the presence of a second element and vice versa.

### LIST OF REFERENCES

2 wind turbine
4 tower
6 nacelle
8 hub
10 blade
14 blade tip
15 tip end
16 blade root
17 root end
18 leading edge
20 trailing edge
24 first blade shell part (pressure side)
26 second blade shell part (suction side)
28 bond lines/glue joints
30 root region
32 transition region
34 airfoil region
40 shoulder
100 system
102 first mould
103 first moulding surface
104 second mould
105 second moulding surface
106 monorail
110 primary mobile unit
112 first distributor
113 first fibre material
114 first cover handler
115 first cover material
116 previously distributed fibre material in first mould
118 first secondary cover handler
119 first secondary cover material
120 secondary mobile unit
122 second distributor
123 second fibre material
124 second cover handler
125 second cover material
126 previously distributed fibre material in second mould
128 second secondary cover handler
129 second secondary cover material
130 controller
200 method
202 arranging first mould
204 arranging second mould
206 arranging monorail
208 mounting primary mobile unit
210 distributing first fibre material
212 arranging first cover material
214 distributing second fibre material
216 arranging second cover material
218 mounting secondary mobile unit
220 lifting first cover material
221 lifting second cover material
222 lifting first secondary cover material
223 lifting second secondary cover material

1-25. (canceled)

26. A system for manufacturing a composite wind turbine blade, comprising:
a first mould arranged along a longitudinal direction, the first mould configured to form a first part of the composite wind turbine blade;
a second mould arranged substantially along the longitudinal direction, the second mould configured to form a second part of the composite wind turbine;
a monorail arranged between the first mould and the second mould along he longitudinal direction;
a primary mobile unit mountable on the monorail and comprising:
a first distributor that distributes a first fibre material in the first mould; and
a first cover handler that arranges a first cover material over the first fibre material in the first mould to lock the first fibre material in the first mould.

27. The system according to claim 26, further comprising:
a second distributor that distributes a second fibre material in the second mould; and
a second cover handler that arranges a second cover material over the second fibre material in the second mould to lock the second fibre material in the second mould.

28. The system according to claim 27, wherein the second distributor and the second cover handler are configured on the primary mobile unit or on a secondary mobile unit.

29. The system according to claim 28, wherein the primary mobile unit and the secondary mobile unit are movable along the monorail along the longitudinal direction.

30. The system according to claim 28, further comprising controller configured to control movement or operation of any one or combination of the primary mobile unit, the secondary mobile unit, the first distributor, the first cover handler, the second distributor, or the second cover handler.

31. The system according to claim 28, wherein the controller controls operation of the first distributor and the first cover handler to coordinate distribution of the first fibre material and the arrangement of the first cover material over the first fibre material.

32. The system according to claim 26, wherein the first cover material locks the first fibre material in the first mould by gravity-induced friction

33. The system according to claim 27, wherein one or both of the first cover material and the second cover material is a rubber mat.

34. The system according to claim 26, wherein the first cover handler arranges the first cover material over the first fibre material by unrolling the first cover material over the first fibre material.

35. The system according to claim 26, wherein the first cover material is arranged over previously distributed fibre material in the first mould, and wherein the first cover handler is further configured to lift the first cover material from the previously distributed fibre material.

36. The system according to claim 26, wherein a first secondary cover material is arranged over previously distributed fibre material in the first mould, and wherein the primary mobile unit comprises a first secondary cover handler configured to lift the first secondary cover material from the previously distributed fibre material.

37. The system according to claim 26, wherein the monorail is laid on the ground.

38. The system according to claim 26, wherein the monorail is attached to and hanging from a ceiling.

39. The system according to claim 26, wherein the monorail is attached to a wall.

40. A method for manufacturing a composite wind turbine blade, comprising:
arranging a first mould along a longitudinal direction, the first mould configured to form a first part of the composite wind turbine blade;
arranging a second mould along the longitudinal direction, the second mould to form a second part of the composite wind turbine blade;
arranging a monorail between the first mould and the second mould along the longitudinal direction;
mounting a primary mobile unit to the monorail, the primary mobile unit having a first distributor and a first cover handler;
distributing, by the first distributor, a first fibre material in the first mould; and
arranging, by the first cover handler, a first cover material over the distributed first fibre material in the first mould to lock the first fibre material in the first mould.

41. The method according to claim 40, wherein the primary mobile unit includes a second distributor and a second cover handler, and the method comprises distributing, by the second distributor, a second fibre material in the second mould, and arranging, by the second cover handler, a second cover material over the distributed second fibre material in the second mould to lock the second fibre material in the second mould.

42. The method according to claim 40, comprising mounting a secondary mobile unit to the monorail, the secondary mobile unit having a second distributor and a second cover handler, and the method comprises distributing, by the second distributor, a second fibre material in the second mould, and arranging, by the second cover handler, a second cover material over the distributed second fibre material in the second mould to lock the second fibre material in the second mould.

43. The method according to claim 40, wherein the first cover material locks the first fibre material in the first mould by gravity-induced friction.

44. The method according to claim 40, wherein arranging the first cover material over the distributed first fibre material comprises unrolling the first cover material over the distributed first fibre material.

45. The method according to claim 40, wherein the first cover material is arranged over previously distributed fibre material in the first mould, and wherein the method comprises lifting the first cover material by the first cover handler before distributing the first fibre material.

46. The method according to claim 40, wherein a first secondary cover material is arranged over previously distributed fibre material in the first mould, and wherein the method comprises lifting the first secondary cover material by a first secondary cover handler of the primary mobile unit before distributing the first fibre material.

47. The method according to claim 40, wherein arranging the monorail comprises laying the monorail on the ground.

48. The method according to claim 40, wherein arranging the monorail comprises attaching the monorail to a ceiling.

49. The method according to claim 40, wherein arranging the monorail comprises attaching the monorail to a wall.
